(19) United States
(12) Patent Application Publication
(10) Pub. No.: US 2007/0263250 A1
(43) Pub. Date: Nov. 15, 2007

(54) ELECTRONIC CONTROL DEVICE, CONTROL METHOD THEREFOR, AND PROGRAM THEREFOR

(75) Inventor: Masahiro KOIWAI, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Tokyo (JP)

(21) Appl. No.: 11/749,014

(22) Filed: May 15, 2007

(30) Foreign Application Priority Data
May 15, 2006 (JP) 2006135534

(51) Int. Cl. G06F 3/12

(52) U.S. Cl. 358/1.15

(57) ABSTRACT

An electronic control device that operates at a set operation clock frequency includes a power supply device connector that allows connection with a power supply device so that electric power is received from the power supply device; a power supply device information acquisition unit that acquires via the power supply device connector from the power supply device information on the maximum power supplied from the power supply device; one or more electric device connectors that allow connection with one or more electric devices, which are different from the power supply device, so that electric power is output to the one or more electric devices; an electric device information acquisition unit that acquires via the one or more electric device connectors from the one or more electric devices information on the maximum power consumptions of the one or more electric devices; and an operation clock frequency setting unit that sets an operation clock frequency of the electronic control device on the basis of the maximum power supplied from the power supply device included in the information acquired by the power supply device information acquisition unit, the maximum power consumptions of the one or more electric devices included in the information acquired by the electric device information acquisition unit, and a range of the power consumption of the electronic control device that can be set.

### BACKGROUND

1. Technical Field

The present invention relates to electronic control devices, control methods therefor, and programs therefor.

2. Related Art

A print server board that is capable of changing the maximum current consumption of the print server board has been known. For example, a print server board described in Japanese Patent No. 3472086 is capable of setting, as an operation frequency of a central processing unit (CPU) of the print server board, three types of clock frequencies. The print server board is capable of changing the maximum current consumption at three levels by changing the operation frequency of the CPU at three levels in accordance with the magnitude of a power supply current that can be supplied from a printer to the print server board.

However, the print server board described in Japanese Patent No. 3472086 is designed without consideration of current supply from the print server board to an external device connected to the print server board, and the operation frequency of the CPU is determined based on the assumption that most of the input current is consumed by the print server board. Thus, a sufficient current may not be able to be supplied to the connected external device.

### SUMMARY

An advantage of some aspects of the invention is that an electronic control device, a control method for the electronic control device, and a program for the electronic control device are provided in which electric power supplied from a power supply device is appropriately distributed to and used by the electronic control device and one or more electric devices connected to the electronic control device.

In order to achieve at least an aspect of the invention, an electronic control device according to an aspect of the invention that operates at a set operation clock frequency includes a power supply device connector that allows connection with a power supply device so that electric power is received from the power supply device; a power supply device information acquisition unit that acquires via the power supply device connector from the power supply device information on the maximum power supplied from the power supply device; one or more electric device connectors that allow connection with one or more electric devices, which are different from the power supply device, so that electric power is output to the one or more electric devices; an electric device information acquisition unit that acquires via the one or more electric device connectors from the one or more electric devices information on the maximum power consumptions of the one or more electric devices; and an operation clock frequency setting unit that sets an operation clock frequency of the electronic control device on the basis of the maximum power supplied from the power supply device included in the information acquired by the power supply device information acquisition unit, the maximum power consumptions of the one or more electric devices included in the information acquired by the electric device information acquisition unit, and a range of the power consumption of the electronic control device that can be set.

After acquiring via the power supply device connector from the power supply device the information on the maximum power supplied from the power supply device and acquiring via the one or more electric device connectors from the one or more electric devices the information on the maximum power consumptions of the one or more electric devices, the electronic control device sets an operation clock frequency of the electronic control device on the basis of the maximum power supplied from the power supply device included in the information acquired by the power supply device information acquisition unit, the maximum power consumptions of the one or more electric devices included in the information acquired by the electric device information acquisition unit, and a range of the power consumption of the electronic control device that can be set. As described above, since the electronic control device sets the operation clock frequency of the electronic control device in consideration of not only the maximum power supplied from the power supply device connected to the electronic control device and the power consumption of the electronic control device but also the maximum power consumptions of the one or more electric devices, the power consumption of the electronic control device and the power consumptions of the one or more electric devices connected to the electronic control device can be set in consideration of not only an operation of the electronic control device but also an operation of each of the one or more electric devices connected to the electronic control device. Thus, the electric power supplied from the power supply device can be distributed to and used by the electronic control device and the one or more electric devices connected to the electronic control device.

It is preferable that the electronic control device further includes a detector that detects that a new electric device is connected to one of the one or more electric device connectors. In addition, it is preferable that when the detector detects that the new electric device is connected to the one of the one or more electric device connectors, the operation clock frequency setting unit acquires, via the electric device information acquisition unit, information on the maximum power consumption of the new electric device and resets the operation clock frequency of the electronic control device. Thus, the electronic control device is capable of detecting that a new electric device is connected to the electronic control device. In addition, the electronic control device is capable of resetting the operation clock frequency of the electronic control device taking into consideration an operation of the new electric device.

It is preferable that the operation clock frequency setting unit calculates the upper limit of the power consumption of the electronic control device on the basis of a difference between the maximum power supplied from the power supply device included in the information acquired by the power supply device information acquisition unit and the total sum of the maximum power consumptions of the one or more electric devices included in the information acquired by the electric device information acquisition unit, and resets the operation clock frequency of the electronic control device within a range in which the calculated upper limit of the power consumption of the electronic control device is not exceeded. Thus, the electronic control device is capable of setting the operation clock frequency of the electronic control device while prioritizing an operation of each of the one or more electric devices connected to the electronic control device.

It is preferable that when an operation clock frequency that can be set within the range in which the calculated upper limit of the power consumption of the electronic control device is not exceeded exists, the operation clock frequency setting unit sets the maximum operation clock frequency within the range in which the calculated upper limit of the power consumption of the electronic control device is not exceeded. Thus, if an operation clock frequency that can be set within the range in which the calculated upper limit of the power consumption of the electronic control device is not exceeded exists, by setting the maximum operation clock frequency within the range, the electric power supplied from the power supply device connected to the electronic control device can be most effectively used by the electronic control device and the one or more electric devices connected to the electronic control device.

It is preferable that when one of the one or more electric devices is operable with a power consumption that is lower than a corresponding maximum power consumption, the operation clock frequency setting unit sets the operation clock frequency of the electronic control device using the lower power consumption instead of the corresponding maximum power consumption of the one of the one or more electric devices. Thus, the range of choices for distribution of the maximum power supplied from the power supply device to the electronic control device and the one or more electric devices connected to the electronic control device can be expanded. For example, the power consumptions of the one or more electric devices connected to the electronic control device can be set while prioritizing an operation of the electronic control device. Alternatively, for example, when the power consumption of the electronic control device cannot be set with priority placed on an operation of each of the one or more electric devices connected to the electronic control device, the power consumption of the electronic control device can be set by reducing the power consumption of each of the one or more electric devices.

It is preferable that the one or more electric devices are universal serial bus devices.

A control method according to an aspect of the invention for an electronic control device that includes a power supply device connector allowing connection with a power supply device so that electric power is received from the power supply device and one or more electric device connectors allowing connection with one or more electric devices, which are different from the power supply device, so that electric power is output to the one or more electric devices and that operates at a set operation clock frequency includes acquiring via the power supply device connector from the power supply device information on the maximum power supplied from the power supply device and acquiring via the one or more electric device connectors from the one or more electric devices information on the maximum power consumptions of the one or more electric devices; and setting an operation clock frequency of the electronic control device on the basis of the maximum power supplied from the power supply device included in the information acquired via the power supply device connector from the power supply device, the maximum power consumptions of the one or more electric devices included in the information acquired via the one or more electric device connectors from the one or more electric devices, and a range of the power consumption of the electronic control device that can be set.

In the control method for the electronic control device, after the information on the maximum power supplied from the power supply device is acquired via the power supply device connector from the power supply device and the information on the maximum power consumptions of the one or more electric devices is acquired via the one or more electric device connectors from the one or more electric devices, the operation clock frequency of the electronic control device is set on the basis of the maximum power supplied from the power supply device included in the information acquired by the power supply device information acquisition unit, the maximum power consumptions of the one or more electric devices included in the information acquired by the electric device information acquisition unit, and a range of the power consumption of the electronic control device that can be set. As described above, since the operation clock frequency of the electronic control device is set in consideration of not only the maximum power supplied from the power supply device connected to the electronic control device and the power consumption of the electronic control device but also the maximum power consumptions of the one or more electric devices connected to the electronic control device, the power consumption of the electronic control device and the power consumptions of the one or more electric devices connected to the electronic control device can be set taking into consideration of not only an operation of the electronic control device but also an operation of each of the one or more electric devices connected to the electronic control device. Thus, the electric power supplied from the power supply device can be appropriately distributed to and used by the electronic control device and the one or more electric devices connected to the electronic control device. Processing for attaining an operation or a function to be achieved with various configurations of the above-described electronic control device may be added.

A program according to an aspect of the invention causes one or more computers to perform the above-described control method. This program may be recorded on a computer-readable recording medium (for example, a hard disc, a ROM, a flexible disc (FD), a compact disc (CD), a digital versatile disc (DVD), or the like) or may be distributed from a computer to another computer via a transmission medium (that is, a communication network, such as the Internet or a LAN). Alternatively, the program may be transferred via any types of communication. When the program is executed by a computer or distributed to a plurality of computers and executed by the plurality of computers, the above-mentioned control method is performed. Thus, an advantage similar to that of the above-mentioned control method can be achieved.

### BRIEF DESCRIPTION OF THE DRAWINGS

The invention will be described with reference to the accompanying drawings, wherein like numbers reference like elements.

FIG. 1 is a schematic diagram showing a configuration of a print server according to an embodiment of the invention.

FIG. 2 is a flowchart showing an example of an operation clock setting routine performed by a CPU of a main controller of the print server.

FIG. 3 is a flowchart showing another example of the operation clock setting routine.

### DESCRIPTION OF EXEMPLARY EMBODIMENTS

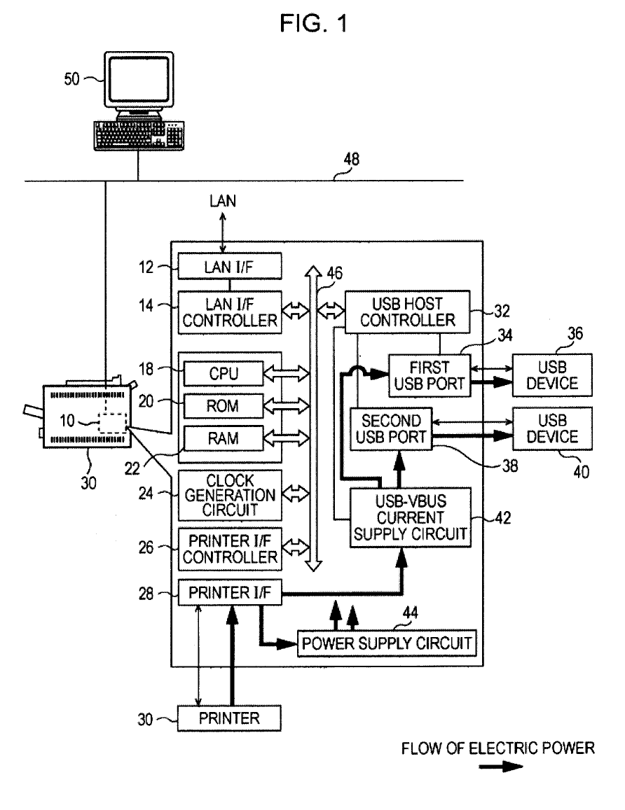

Embodiments of the invention will be described with reference to the drawings. FIG. 1 is a schematic diagram showing a configuration of a print server 10, which is an electronic device, according to an embodiment of the invention. The print server 10 is formed on a board and is used in a state in which the print server 10 is inserted in one of a plurality of expansion slots (not shown) of a printer 30. The print server 10 includes a printer interface controller 26 transferring data to and from the printer 30 through a printer interface 28 and controlling input of a current from the printer 30 through the printer interface 28; a local-area network (LAN) interface controller 14 for receiving a print instruction and print data from a computer 50 connected to a LAN 48 through a LAN interface 12; a universal serial bus (USB) host controller 32 transferring data to and from USB devices 36 and 40 connected to first USB port 34 and a second USB port 38, respectively; a USB-VBUS current supply circuit 42 supplying a current to each of the USB devices 36 and 40 by using VBUS terminals of USB connectors (not shown); a power supply circuit 44 supplying a current to each of various units of the print server 10; a clock generation circuit 24 generating an operation clock signal of a bus 46; and a main controller 16 generally controlling the entire print server 10. The printer interface controller 26, the LAN interface controller 14, the USB host controller 32, the clock generation circuit 24, and the main controller 16 are capable of transferring various control signals and data via the bus 46.

The printer interface controller 26 is formed on the board. The printer interface controller 26 controls the printer interface 28 to supply to each of the USB-VBUS current supply circuit 42 and the power supply circuit 44 a current received from the printer 30. The printer interface controller 26 also transmits to the printer 30 a print job received from the computer 50 on the LAN 48.

The LAN interface controller 14 transfers data to and from an external apparatus connected to the LAN 48 via the LAN interface 12. The LAN interface controller 14 monitors data communicated on the LAN 48 via a LAN cable connected to a LAN port (not shown), which is provided so as to be exposed on the surface of the printer 30, of the LAN interface 12, and receives data having a header identifying an IP address of the printer 30. Data received by the LAN interface controller 14 is, for example, a print job transmitted from the computer 50.

The USB host controller 32 controls the USB devices 36 and 40 connected to a USB bus through the first USB port 34 and the second USB port 38, respectively. In accordance with an instruction from the main controller 16, the USB host controller 32 transfers data to and from the USB devices 36 and 40, instructs the USB-VBUS current supply circuit 42 to supply a current to each of the USB devices 36 and 40, transfers to the main controller 16 acquired information on a USB device when the power of the print server 10 is turned on or when a new USB device is connected to the USB bus, and sets an operation environment suitable for each USB device. Each USB device stores data having a data structure called a descriptor in which information on the attribute of the USB device is described. Information on the maximum current consumption of the USB device is described in data having a data structure called a configuration descriptor.

The USB-VBUS current supply circuit 42 supplies a current to each of the USB devices 36 and 40. In accordance with an instruction from the USB host controller 32, the USB-VBUS current supply circuit 42 supplies to each of the USB devices 36 and 40 via the first USB port 34 and the second USB port 38, respectively, a current received from the printer 30 via the printer interface 28.

The power supply circuit 44 supplies a current to each of portions of the print server 10 relating to an operation of the print server 10. The power supply circuit 44 supplies to each of the main controller 16, the LAN interface controller 14, the clock generation circuit 24, the printer interface controller 26, and the USB host controller 32 a current received from the printer 30 via the printer interface 28.

The clock generation circuit 24 generates an operation clock signal of the bus 46. The clock generation circuit 24 includes a multiplier circuit, a frequency divider circuit, and the like. When an operation clock setting routine, which will be described below, is executed by the main controller 16 and an operation mode is set, the clock generation circuit 24 generates an operation clock signal corresponding to the set operation mode in accordance with an instruction from the main controller 16. In this embodiment, as an operation mode, a low-speed mode in which an operation is performed at an operation clock frequency of 66 MHz, a medium-speed mode in which an operation is performed at an operation clock frequency of 100 MHz, and a high-speed mode in which an operation is performed at an operation clock frequency of 200 MHz, can be set. The relationship between an operation clock frequency and the maximum current consumption of the print server 10 at the operation clock frequency is shown in Table 1.

TABLE 1

| Operation Clock Frequency | Maximum Current Consumption |
|---|---|
| (MHz) | (mA) |
| 66 | 300 |
| 100 | 500 |
| 200 | 800 |

The main controller 16 includes a CPU 18 controlling the entire device, a read-only memory (ROM) 20 storing various programs, a random-access memory (RAM) 22 temporarily storing data, and the like.

The print server 10 according to this embodiment configured as described above has a print server function of receiving a print job from the computer 50 or the like on the LAN 48 and causing the printer 30 connected to the printer interface 28 to perform printing in accordance with the print job. The print server 10 also has a USB host function of supplying to each of the USB devices 36 and 40 connected to the first USB port 34 and the second USB port 38, respectively, a current received from the printer 30 via the printer interface 28 and transferring data to and from the USB devices 36 and 40.

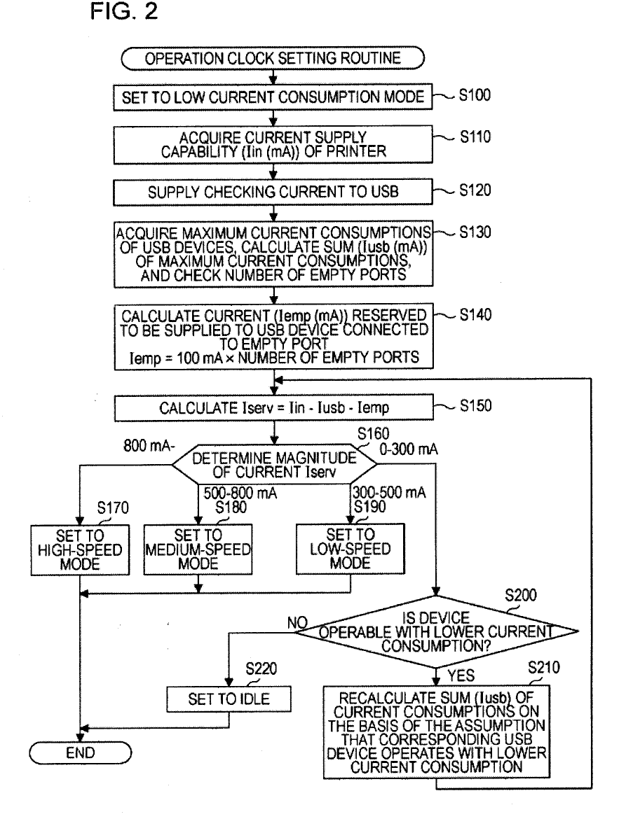

An operation of the print server 10 according to this embodiment configured as described above is described next. FIG. 2 is a flowchart showing an example of an operation clock setting routine executed by the CPU 18 of the main controller 16 when the power of the print server 10 is turned on or when each of the USB devices 36 and 40 is connected or disconnected. When the operation clock setting routine starts, the CPU 18 of the main controller 16 starts an operation in a predetermined low current consumption mode (step S100). The low current consumption mode is a mode in which an operation is performed with a low current consumption that is sufficient only to acquire information on the maximum current that can be received from the printer 30, the maximum current consumptions of the devices 36 and 40, and the like. In this embodiment, in the low current consumption mode, an operation is performed at an operation clock frequency of 33 MHz. Then, the CPU 18 acquires information on the maximum current supply capability Iin (mA) of the printer 30 via the printer interface 28 (step S110). The CPU 18 controls the USB-VBUS current supply circuit 42 to supply to all the USB ports checking currents for checking USB devices (step S120). The CPU 18 acquires from a configuration descriptor of a USB device information on the maximum current consumption of the USB device that receives a checking current, calculates a current consumption sum Iusb (mA), and checks the number of USB ports that are not connected to USB devices (hereinafter, referred to as empty ports) (step S130). The CPU 18 calculates a current Iemp (mA) reserved to be supplied to a USB device to be connected to an empty port (step S140). Since it is defined by the USB standard that a USB device has to operate with a maximum current consumption of 100 mA immediately after the USB device is connected to a USB host, the current Iemp is calculated by multiplying 100 mA by the number of empty ports in this embodiment. The CPU 18 calculates a current Iserv (mA) that can be used for an operation of the print server 10 by subtracting the sum Iusb (mA) of the maximum current consumptions of USB devices and the current Iemp (mA) reserved to be supplied to the USB device to be connected to the empty port from the maximum current supply capability Iin (mA) of the printer 30 (step S150).

Then, the CPU 18 determines the magnitude of the current Iserv (mA) obtained by the processing of step S150 as a current that can be used for the operation of the print server 10 (step S160). If it is determined in step S160 that the current Iserv is 800 mA or more, the operation mode of the print server 10 is set to the high-speed mode (step S170). Then, the operation clock setting routine is terminated. The high-speed mode is a mode in which an operation is performed at an operation clock frequency of 200 MHz and with a maximum current consumption of 800 mA, as described above. For example, the high-speed mode is set when the maximum current supply capability Iin of the printer 30 is 1000 mA and a USB device is connected to neither the first USB port 34 nor the second USB port 38. In this case, since there are two empty ports, the current Iemp is 200 mA. Thus, a current Iserv of 800 mA is obtained by subtracting the current Iemp 200 mA from the maximum current supply capability Iin 1000 mA. If it is determined in step S160 that the current Iserv is equal to or more than 500 mA and less than 800 mA, the operation mode of the print server 10 is set to the medium-speed mode (step S180). Then, the operation clock setting routine is terminated. The medium-speed mode is a mode in which an operation is performed at an operation clock frequency of 100 MHz and with a maximum current consumption of 500 mA, as described above. For example, the medium-speed mode is set when the maximum current supply capability Iin of the printer 30 is 800 mA and a USB device having a maximum current consumption of 100 mA is connected only to the first USB port 34. In this case, since there is an empty port, the current Iemp is 100 mA. Thus, a current Iserv of 600 mA is obtained by subtracting the current consumption sum Iusb 100 mA and the current Iemp 100 mA from the maximum current supply capability Iin 800 mA. If it is determined in step S160 that the current Iserv is equal to or more than 300 mA and less than 500 mA, the operation mode of the print server 10 is set to the low-speed mode (step S190). Then, the operation clock setting routine is terminated. The low-speed mode is a mode in which an operation is performed at an operation clock frequency of 66 MHz and with a maximum current consumption of 300 mA, as described above. For example, the low-speed mode is set when the maximum current supply capability Iin of the printer 30 is 1000 mA and a USB device having a maximum current consumption of 500 mA is connected only to the first USB port 34. In this case, since there is an empty port, the current Iemp is 100 mA. Thus, a current Iserv of 400 mA is obtained by subtracting the current consumption sum Iusb 500 mA and the current Iemp 100 mA from the maximum current supply capability Iin 1000 mA. If it is determined in step S160 that the current Iserv is less than 300 mA, the process proceeds to step S200. For example, it is determined that the Iserv is less than 300 mA when the maximum current supply capability Iin of the printer 30 is 800 mA and a USB device having a maximum current consumption of 500 mA is connected only to the first USB port 34. In this case, since there is an empty port, the current Iemp is 100 mA. Thus, a current Iserv of 200 mA is obtained by subtracting the current consumption sum Iusb 500 mA and the current Iemp 100 mA from the maximum current supply capability Iin 800 mA.

After it is determined in step S160 that the current Iserv is less than 300 mA, it is determined in step S200 whether or not each USB device is operable with a current consumption that is lower than the current consumption regarded as being necessary for the USB device at that time. If it is determined in step S200 that the USB device is operable with a lower current consumption, the CPU 18 instructs the USB device to operate with the lower current consumption, acquires information on the lower current consumption, and recalculates the current consumption sum Iusb (mA) on the basis of the assumption that the USB device operates with the lower current consumption (step S210). Then, the process returns to step S150 to recalculate the current Iserv (mA) that can be used for the operation of the print server 10. Then, in step S160, the CPU 18 determines the magnitude of the current Iserv. If it is determined in step S160 that the current Iserv is less than 300 mA and it is determined in step S200 that a USB device is operable with a lower current consumption, the processing of steps S210, S150, S160, and S200 is repeated. If it is determined in step S160 that the current Iserv is equal to or more than 300 mA, an operation mode corresponding to the magnitude of the current Iserv is set in corresponding step S170, S180, or S190. Then, the operation clock setting routine is terminated. If it is determined in step S200 that no USB device is operable with a lower current consumption, a predetermined idle state is set (step S220). Then, the operation clock setting routine is terminated. In this embodiment, in the predetermined idle state, the operation mode is set to none of the low-speed mode, the medium-speed mode, and the high-speed mode. In addition, in the predetermined idle state, an indicator lamp (not shown) provided on the surface of the print server 10 is turned on so as to report to a user that no operation mode can be set.

A case where a new USB device is connected to a USB port after the above-described operation clock setting routine is executed and an operation mode is set will be described. For example, when the power of the print server 10 is turned on in a state in which the USB device 36 is connected only to the first USB port 34, the above-described operation clock setting routine is executed and an operation mode is set. After that, the USB device 40 is connected to the second USB port 38. In this case, before the USB device 40 is connected to the second USB port 38, an operation mode is set on the basis of the maximum current consumption of the USB device 36 and the maximum current supply capability of the printer 30. After the USB device 40 is connected to the second USB port 38, the above-described operation clock setting routine is executed in order to reset an operation mode in consideration of the maximum current consumption of the USB device 40. In this case, the sum Iusb (mA) of current consumptions of USB devices calculated by the processing of step S130 is equal to the sum of the maximum current consumption of the USB device 36 and the maximum current consumption of the USB device 40. In addition, in step S200, it is determined not only whether or not the USB device 36 is operable with a lower current consumption but also whether or not the USB device 40 is operable with a lower current consumption. Although a case where the USB device 40 is newly connected to the second USB port 38 has been described above, when the USB device 36 is connected to or disconnected from the first USB port 34, the above-described operation clock setting routine is also executed to set an operation mode.

The correspondence between elements in this embodiment and elements in an aspect of the invention will be described. The printer interface 28 in this embodiment corresponds to a power supply device connector in an aspect of the invention. The first USB port 34 and the second USB port 38 in this embodiment correspond to electric device connectors in an aspect of the invention. The main controller 16 in this embodiment corresponds to an operation clock frequency setting unit in an aspect of the invention. The main controller 16 and the printer interface controller 26 in this embodiment correspond to a power supply device information acquisition unit in an aspect of the invention. The main controller 16 and the USB host controller 32 in this embodiment correspond to an electric device information acquisition unit. In this embodiment, an example of a control method for an electric control device according to an aspect of the invention is clarified by explaining an operation of the print server 10.

The print server 10 according to this embodiment sets an operation clock frequency of the bus 46 of the print server 10 in consideration of the total sum (Iusb) of the maximum current consumptions of USB devices connected to the print server 10 as well as the maximum current supply capability (Iin) of the printer 30 connected to the print server 10 and the current consumption (Iserv) of the print server 10. Thus, the current consumption of the print server 10 and the current consumptions of the USB devices connected to the print server 10 can be set in consideration of not only an operation of the print server 10 but also an operation of each of the USB devices connected to the print server 10. Therefore, the current supplied from the printer 30 can be appropriately distributed to and used by the print server 10 and one or more USB devices connected to the print server 10.

In addition, when a new USB device is connected to the print server 10, the print server 10 detects the connection and resets the operation clock frequency of the bus 46 of the print server 10 in consideration of an operation of the newly connected USB device.

In addition, in step S160 of the operation clock setting routine, the magnitude of the current Iserv (mA), which can be used for the operation of the print server 10, is calculated on the basis of a difference between the maximum current supply capability of the printer 30 and the total sum of the maximum current consumptions of USB devices, and an operation mode corresponding to the magnitude of the current Iserv is set. Thus, the operation clock frequency of the bus 46 of the print server 10 can be set while prioritizing an operation of each of the USB devices.

In addition, in step S160 of the operation clock setting routine, thresholds (300 mA, 500 mA, and 800 mA in this embodiment) used for determination of the magnitude of the current Iserv correspond to the maximum current consumptions of the print server 10 when the operation clock frequency of the bus 46 is set to 66 MHz in the low-speed mode, 100 MHz in the medium-speed mode, and 200 MHz in the high-speed mode, respectively, and an operation mode is set on the basis of the magnitude of the current Iserv at that time. Thus, if an operation clock frequency of the bus 46 of the print server 10 that can be set within a range in which the calculated current Iserv is not exceeded exists, the maximum operation clock frequency in the range is set. Thus, the print server 10 and one or more USB devices connected to the print server 10 are able to most effectively use the current supplied from the printer 30 connected to the print server 10.

If it is determined in step S160 of the operation clock setting routine that the current Iserv is less than 300 mA, it is determined in step S200 whether or not each USB device is operable with a current consumption that is lower than the current consumption regarded as being necessary for the USB device at that time. If it is determined in step S200 that the USB device is operable with a lower current consumption, the USB device is instructed to operate with the lower current consumption. Information on the lower current consumption is acquired, and the current consumption sum Iusb (mA) is recalculated on the basis of the assumption that the USB device operates with the lower current consumption. Thus, when the operation clock frequency of the bus 46 of the print server 10 cannot be set, the current consumption of the USB device 36 or 40 is reduced so that the operation clock frequency of the bus 46 of the print server 10 can be set.

The invention is not limited to the foregoing embodiment. Obviously, various modifications can be made to the invention without departing from the technical scope of the invention.

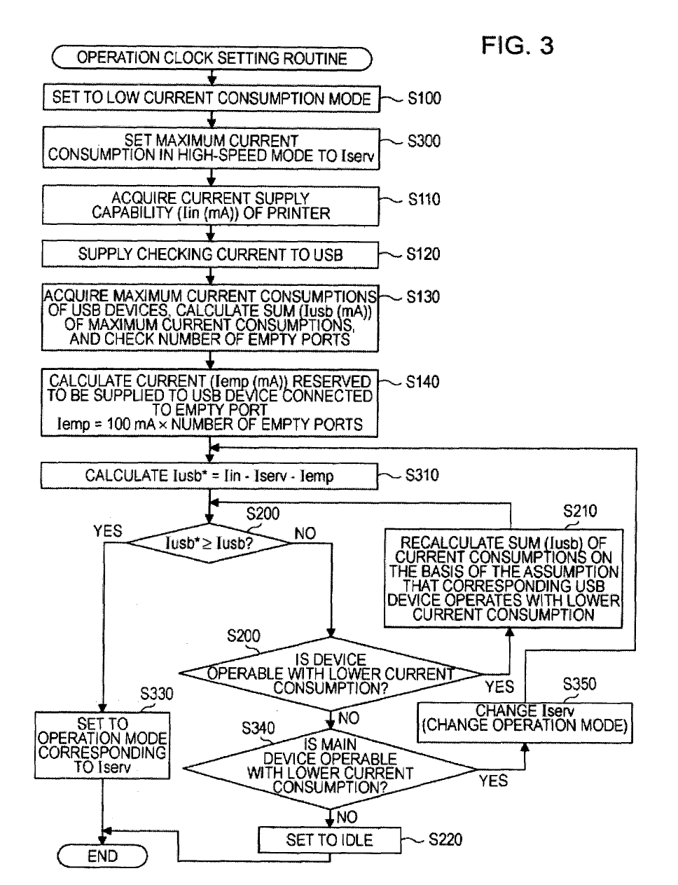

For example, although the operation clock setting routine shown in FIG. 2 has been described in the foregoing embodiment, an operation clock setting routine shown in FIG. 3 may be adopted. An operation clock setting routine is described next with reference to FIG. 3. In the operation clock setting routine shown in FIG. 3, the same processing blocks as in the operation clock setting routine shown in FIG. 2 are referred to with the same step numbers, and the descriptions of those same processing blocks will be omitted. When the operation clock setting routine shown in FIG. 3 starts, the CPU 18 of the main controller 16 performs the processing of step S100. Then, the CPU 18 sets the current Iserv to the maximum current consumption (800 MA) corresponding to the high-speed mode of the print server 10 (step S300). Then, the CPU 18 performs the processing of steps S110, S120, S130, and S140 in order. Then, the CPU 18 calculates a current Iusb* that can be supplied to USB devices by subtracting the current Iserv consumed by the print server 10 and the current Iemp reserved to be supplied to a USB device connected to an empty device from the maximum current supply capability Iin of the printer 30 (step S310). The CPU 18 determines whether or not the current Iusb* is equal to or more than the sum Iusb (mA) of current consumptions of the USB devices calculated by the processing of step S130 (step S320). If it is determined in step S320 that the current Iusb* is equal to or more than the sum Iusb of the current consumptions, since a current necessary for the USB devices can be supplied, an operation mode corresponding to the magnitude of the current Iserv set at that time is set (step S330). Then, the operation clock setting routine is terminated. In this case, the high-speed mode, which is set in step S300, is set. If it is determined in step S320 that the current Iusb* is less than the sum Iusb of the current consumptions, the process proceeds to step S200. If it is determined in step S200 that a USB device is operable with a lower current consumption, the process proceeds to step S210 to recalculate the sum Iusb of the current consumptions. Then, it is determined in step S320 that the current Iusb* is equal to or more than the sum Iusb of the current consumptions. If the determination in step S320 is negative and the determination in step S200 is affirmative, the processing of steps S200, S210, and S320 is repeated. If it is determined in step S320 that the current Iusb* is equal to or more than the sum Iusb of the current consumptions, an operation mode corresponding to the magnitude of the current Iserv set at that time is set (step S330). Then, the operation clock setting routine is terminated. In this case, the high-speed mode, which is set in step S300, is set. In addition, the current consumption of a USB device is set to a value used when the current consumption sum Iusb is last calculated in step S210. In addition, if the determination of step S200 is negative when the processing of steps S200, S210, and S320 is repeated, the current consumption of no USB device can be reduced. Thus, it is determined whether or not the print server 10 is operable in an operation mode using a lower current consumption (step S340). If it is determined in step S340 that the print server 10 is operable in an operation mode using a lower current consumption, the operation mode using the lower current consumption is set and the current Iserv is reduced (step S350). Then, the CPU 18 recalculates the current Iusb* on the basis of the changed current Iserv in step S310, and determines in step S320 whether or not the current Iusb* is equal to or more than the current consumption sum Iusb. If the determination of step S320 is negative and the determination of step S340 is affirmative, the processing of steps S340, S350, S310, S320, and S200 is repeated. If it is determined in step S320 that the current Iusb* is equal to or more than the current consumption sum Iusb, an operation mode corresponding to the magnitude of the current Iserv set at that time is set (step S330). Then, the operation clock setting routine is terminated. If the determination of step S340 is negative when the processing of steps S340, S350, S310, S320, and S200 is repeated, the operation mode of the print server 10 cannot be changed to an operation mode using a lower current consumption. Thus, the process proceeds to step S220. Then, the operation clock setting routine is terminated. Accordingly, a current consumption of each USB device connected to the print server 10 can be set while prioritizing the operation of the print server 10.

Although a case where two USB ports are provided has been described in the foregoing embodiments, the number of USB ports is not particularly limited. For example, in a case where four USB ports are provided, after information on the maximum current consumptions of all the USB devices connected to the four USB ports is acquired, the operation clock frequency of the bus 46 is set on the basis of the total sum of the maximum current consumptions and the maximum current supply capability Iin of the printer 30.

Although information on the maximum current consumptions of USB devices is acquired after a current is collectively supplied to all the USB devices in the foregoing embodiments, information on the maximum current consumptions of all the USB devices connected to the print server 10 may be acquired by sequentially repeating processing of stopping current supply after supplying a current to one of the USB device and acquiring information on the maximum current consumption of the USB device.

Although the print server 10 supplies a current to a USB device in the foregoing embodiments, the print server 10 may supply a current to a device that is connected to the print server 10 by a connection method other than USB connection, as long as the print server 10 is capable of acquiring information on the maximum current consumption of the device connected to the print server 10. In this case, a controller and a connection port suitable for the device are provided.

Although three levels of operation clock frequency, such as 66 MHz in the low-speed mode, 100 MHz in the medium-speed mode, and 200 MHz in the high-speed mode, can be set as an operation clock frequency of the bus 46 of the print server 10 in the foregoing embodiments, three or more levels of operation clock frequency may be able to be set.

Although three levels of operation clock frequency, such as 66 MHz in the low-speed mode, 100 MHz in the medium-speed mode, and 200 MHz in the high-speed mode, can be set as an operation clock frequency of the bus 46 of the print server 10 in the foregoing embodiments, consecutive operation clock frequencies may be able to be set. In this case, since the operation clock frequency of the bus 46 of the print server 10 can be set such that the maximum current consumption of the print server 10 is substantially equal to the current Iserv that can be used for the operation of the print server 10, the current received from the printer 30 can be most effectively used.

Although a case where a USB device other than a USB hub has been described in the foregoing embodiments, a USB hub may be connected. In this case, a current Iemp and a cur-rent consumption sum Iusb are calculated and checking of empty ports is performed with respect to all the USB ports including USB ports provided in the USB hub.

Although an aspect of the invention is applied to the print server 10 in the foregoing embodiments, an aspect of the invention may be applied to any type of electronic device, as long as the electronic device is capable of receiving a current from an external apparatus, using the received current distributed to the electronic device and an external device connected to the electronic device, and changing an operation clock of the electronic device.

What is claimed is:

1. An electronic control device that operates at a set operation clock frequency, comprising:
a power supply device connector that allows connection with a power supply device so that electric power is received from the power supply device;
a power supply device information acquisition unit that acquires via the power supply device connector from the power supply device information on the maximum power supplied from the power supply device;
one or more electric device connectors that allow connection with one or more electric devices, which are different from the power supply device, so that electric power is output to the one or more electric devices;
an electric device information acquisition unit that acquires via the one or more electric device connectors from the one or more electric devices information on the maximum power consumptions of the one or more electric devices; and
an operation clock frequency setting unit that sets an operation clock frequency of the electronic control device on the basis of the maximum power supplied from the power supply device included in the information acquired by the power supply device information acquisition unit, the maximum power consumptions of the one or more electric devices included in the information acquired by the electric device information acquisition unit, and a range of the power consumption of the electronic control device that can be set.

2. The electronic control device according to claim 1, further comprising:
a detector that detects that a new electric device is connected to one of the one or more electric device connectors,
wherein when the detector detects that the new electric device is connected to the one of the one or more electric device connectors, the operation clock frequency setting unit acquires, via the electric device information acquisition unit, information on the maximum power consumption of the new electric device and resets the operation clock frequency of the electronic control device.

3. The electronic control device according to claim 1, wherein the operation clock frequency setting unit calculates the upper limit of the power consumption of the electronic control device on the basis of a difference between the maximum power supplied from the power supply device included in the information acquired by the power supply device information acquisition unit and the total sum of the maximum power consumptions of the one or more electric devices included in the information acquired by the electric device information acquisition unit, and resets the operation clock frequency of the electronic control device within a range in which the calculated upper limit of the power consumption of the electronic control device is not exceeded.

4. The electronic control device according to claim 3, wherein when an operation clock frequency that can be set within the range in which the calculated upper limit of the power consumption of the electronic control device is not exceeded exists, the operation clock frequency setting unit sets the maximum operation clock frequency within the range in which the calculated upper limit of the power consumption of the electronic control device is not exceeded.

5. The electronic control device according to claim 1, wherein when one of the one or more electric devices is operable with a power consumption that is lower than a corresponding maximum power consumption, the operation clock frequency setting unit sets the operation clock frequency of the electronic control device using the lower power consumption instead of the corresponding maximum power consumption of the one of the one or more electric devices.

6. The electronic control device according to claim 1, wherein the one or more electric devices are universal serial bus devices.

7. A control method for an electronic control device that includes a power supply device connector allowing connection with a power supply device so that electric power is received from the power supply device and one or more electric device connectors allowing connection with one or more electric devices, which are different from the power supply device, so that electric power is output to the one or more electric devices and that operates at a set operation clock frequency, comprising:
acquiring via the power supply device connector from the power supply device information on the maximum power supplied from the power supply device and acquiring via the one or more electric device connectors from the one or more electric devices information on the maximum power consumptions of the one or more electric devices; and
setting an operation clock frequency of the electronic control device on the basis of the maximum power supplied from the power supply device included in the information acquired via the power supply device connector from the power supply device, the maximum power consumptions of the one or more electric devices included in the information acquired via the one or more electric device connectors from the one or more electric devices, and a range of the power consumption of the electronic control device that can be set.

8. A program for causing one or more computers to perform the control method set forth in claim 7.
